(19) United States
(12) Patent Application Publication
(10) Pub. No.: US 2016/0239176 A1
(43) Pub. Date: Aug. 18, 2016

(54) Dynamic Modification of Content Presentation Based on Attributes of Received Input

(71) Applicant: REALITYGATE (PTY) LTD, Stellenbosch (ZA)

(72) Inventors: Jan Pool, Stellenbosch (ZA); Adri Smuts, Durbanville (ZA); Willem Morkel Van Der Westhuizen, Stellenbosch (ZA); Hendrik Frans Verwoerd Boshoff, Stellenbosch (ZA)

(21) Appl. No.: 15/028,331

(22) PCT Filed: Oct. 21, 2014
(86) PCT No.: PCT/IB14/02942

§ 371 Date: Apr. 8, 2016

Related U.S. Application Data
(60) Provisional application No. 61/894,265, filed on Oct. 22, 2013.

(51) Int. Cl. G06F 3/0488; G06F 3/0484

(52) U.S. Cl. CPC G06F 3/0488; G06F 3/04842

(57) ABSTRACT

A client device presents content items in various regions of a display device. When the client device receives an input associated with a region, the client device determines attributes of the input and modifies presentation of the content items accordingly. For example based on a position of a received input along its axis, a direction of movement of the received input, a veocity associated with the received input, the client device retrieves a model for modifying one or more regions of the display device presenting content items. In various embodiments, models stored by the client device are associatedwith distances from an axis, directions of motion and/or velocities and arc identified based on a suitable attribute of the received input.

### BACKGROUND

This invention relates generally to presentation of content items, and more specifically to modifying presentation of content items based on attributes of a received input.

Increasingly, users access content through client devices having touch sensitive displays. As these client devices become increasingly more portable, their display areas have also become smaller. In addition to limiting the area available for presenting content, smaller touch-sensitive displays limit the inputs available to a user to access different content items through conventional input techniques.

### SUMMARY

Attributes of an input received by a client device are identified. Based on the attributes of the input, content items are presented by the client device, allowing a user to more easily navigate among various content items or to modify presentation of content items. For example, a position of a received input along an axis, a direction of movement of the received input, a velocity associated with the received input, or another suitable attribute associated with the received input is identified by the client device. Based on the attribute, or based on multiple attributes, of the received input, the client device determines an action for modifying presented content items. For example, an attribute of the received input is used to identify a model stored by the client device, which is applied to presented content items to modify the display areas used by the client device to present various content items. In various embodiments, models stored by the client device are associated with distances from an axis, directions of motion and/or velocities and are identified based on a suitable attribute of the received input.

As another example, based on a direction of motion determined for a received input, the client device identifies elements in a hierarchy of data based on the direction of motion. One or more of the identified elements are then presented to the user. Hence, changing the direction of motion of a received input allows a user to navigate through various elements in the hierarchy of data.

### BRIEF DESCRIPTION OF THE DRAWINGS

FIG. 1 is a block diagram of a client device, in accordance with an embodiment of the invention.

FIG. 2 is a flow chart of a method for modifying content presented to a user based on one or more attributes of a received input, in accordance with an embodiment of the invention.

FIGS. 3A-3B are an example of modifying presented content based on an input having a direction associated with a primary axis , in accordance with an embodiment of the invention.

FIGS. 4A-4D are an example of modifying presented content based on an input having a direction associated with a secondary axis, in accordance with an embodiment of the invention.

FIG. 5 is a process flow diagram of selecting and applying a model to modify presentation of content items, in accordance with an embodiment of the invention.

FIGS. 6A-6E are an example of modifying content items presented to a user based on an axis associated with a received input, in accordance with an embodiment of the invention.

FIGS. 7A-7E are an example of navigating through content based on attributes of received inputs, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Architecture

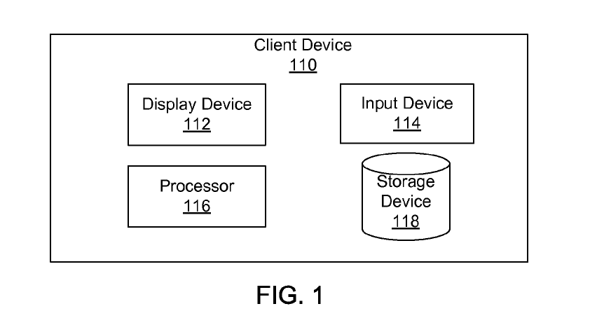

FIG. 1 is a block diagram of a client device 110. The example client device 110 shown by FIG. 1 includes a display device 112, one or more input device 114, a processor 116, and a storage device 118. However, in alternative configurations, the client device 110 may include different and/or additional components than those shown in FIG. 1.

The client device 110 is one or more computing devices capable of receiving user input as well as transmitting and/or receiving data. In one embodiment, the client device 110 is a conventional computer system, such as a desktop computer or a laptop computer. Alternatively, the client device 110 may be a device having computer functionality, such as a personal digital assistant (PDA), a mobile telephone, a smartphone or another suitable device. In one embodiment, the client device 110 executes an application allowing a user of the client device 110 to interact with a content provider or a third party system. For example, an application executing on the client device 110 communicates instructions or requests for content items to a content provider. As another example, the client device 110 executes a browser that receives and presents content from a content provider via the display device 112. In another embodiment, the client device 110 interacts with a content provider through an application programming interface (API) running on a native operating system of the client device 110, such as IOS® or ANDROID™.

A display device 112 included in the client device 110 presents content items to a user of the client device 110. Examples of the display device 112 include a liquid crystal display (LCD), an organic light emitting diode (OLED) display, an active matrix liquid crystal display (AMLCD), or any other suitable device. Different client devices 110 may have display devices 112 with different characteristics. For example, different client devices 112 have display devices 112 with different display areas, different resolutions, or differences in other characteristics.

One or more input devices 114 included in the client device 110 receive input from the user. Different input devices 114 may be included in the client device 110. For example, the client device 110 includes a touch-sensitive display (a “touchscreen”) for receiving input data, commands, or information from a user. Using a touch-sensitive display allows the client device 110 to combine the display device 112 and an input device 114, simplifying user interaction with presented content items. In other embodiments, the client device 110 may include a keyboard, a trackpad, a mouse, or any other device capable of receiving input from a user. Additionally, the client device 110 may include multiple input devices 114 in some embodiments. Inputs received via the input device 114 may be processed by an application associated with a content provider and executing on the client device 110 to allow a client device user to interact with content items presented by the content provider.

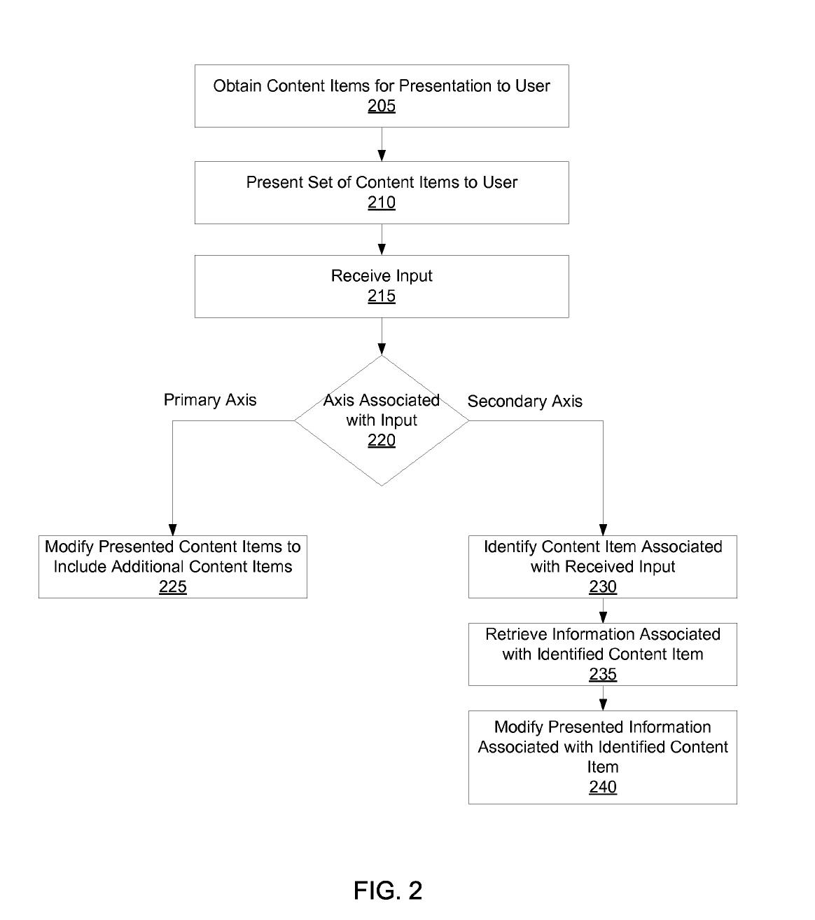

The client device 110 also includes a processor 116, which executes one or more instructions stored in a storage device 118 to provide various functionalities to a user of the client device 110. In one embodiment, the storage device 118 includes models for modifying presentation of one or more content items presented by the display device 112. Modifying presentation of content items based on inputs received via the input device 114 is further described below in conjunction with FIGS. 2-7E.

### Modification of Presented Content Based on Directionality of Received Input

FIG. 2 shows one embodiment of a method for modifying content presented to a user by a client device 110 based on attributes of inputs received via one or more input devices 114 of the client device 110. Instructions describing the functionality discussed below in conjunction with FIG. 2 may be included in the storage device 118 of the client device 110, so the functionality described in conjunction with FIG. 2 is provided when a processor 116 of the client device 110 executes the instructions. In other embodiments, different and/or additional steps than those performed in conjunction with FIG. 2 may be performed. Further, the steps described in conjunction with FIG. 2 may be performed in different orders in some embodiments.

The client device 110 obtains 205 content items for presentation to a user. For example, the client device 110 retrieves one or more content items from a content provider or from a third party system. In some embodiments, the client device 110 may retrieve content items from the storage device 118 of the client device 110. Content items may be obtained 205 from any combination of content providers external to the client device 110 and the storage device 118 of the client device 110. Each received content item may include hierarchical elements describing information about the content item. For example, a content item includes one or more topics, with each topic including images, text data, audio data, video data, or other suitable data describing the topic. Additionally, a content item may be associated with a network address, such as a uniform resource identifier (URI), for retrieving additional information associated with the content item or additional content items from the content provider or from a third party system. A content item may also be associated with an address of a storage location on the client device 110 for obtaining additional information associated with the content item or for obtaining additional content items from the client device 110.

A set of including a plurality of the content items is generated from the obtained content items and presented 210 to the user via the display device 112 of the client device 110. In one embodiment, a list including the set of content items is presented 210 via the display device 112. For example, information associated with the received content items is used to generate a ranking or other ordering of the obtained content items, and a set of content items are presented 210 based at least in part on the ranking. In some embodiments, content items having at least a threshold position in the ranking are included in the set of content items and presented 210 to the user. Information associated with various content items in the set is presented 210, allowing the user to identify different content items in the set. Example information associated with a content item includes: a description of the content item, a title of the content item, and a source from which the content item was obtained. For example, the content items are search results presented 210 in a list based on the relevance of each search result to a received search query. As another example, the content items are advertisements presented 210 in a list based on bid amounts associated with the advertisements or based on a measure of relevance of the advertisements to the user (e.g., targeting criteria associated with advertisements satisfied by characteristics of the user, association between advertisements and a search query received from the user, etc.). The content items may be presented 210 so that different content items are associated with different regions of the display device 112 of the client device 110.

While the set of content items is presented 210 on the display device 112, the client device 110 receives 215 an input from the user via one or more input devices 114. For example, the user contacts a portion of a touch sensitive display with a finger, a stylus, or another object and maintains physical contact with the touch sensitive display while traversing from the portion to an additional portion of the touch sensitive display. The client device 110 determines 220 an axis associated with the input based on the direction of the input. Information stored by the client device 110 identifies a primary axis and a secondary axis, and determines 220 whether the input is associated with the primary axis or is associated with the secondary axis. For example, the client device 110 determines whether a direction of the input (e.g., a direction of a path from a portion of an input device 114 to an additional portion of the input device 114) is within a threshold distance of the primary axis (e.g., the direction of the input is within a threshold angle from the primary axis). In various embodiments, the primary axis is orthogonal to the secondary axis. The primary and secondary axes may be relative to the orientation of the client device 110, as determined by one or more sensors included in the client device 110. For example, if the display device 112 is vertically-oriented, information stored by the client device 110 indicates the primary axis is vertical and the secondary axis is horizontally; in this example, if the display device 112 is horizontally-oriented, information stored in the client device 110 indicates the primary axis is horizontal and the secondary axis is vertical. Alternatively, the primary axis and the secondary axis are independent of the orientation of the client device 110; for example, the primary axis is vertical and the secondary axis is horizontal whether the display device 114 is horizontally or vertically oriented.

The client device 110 may determine 220 the axis associated with the input based on by the relative position of the position of an input device 114 initially contacted to an additional position of the input device 114 contacted by the user. For example, if the additional position is vertically oriented relative to the initially contacted position, the client device 110 determines 220 the input is associated with the primary axis and determines 220 the input is associated with the secondary axis if the additional position is horizontally oriented relative to the initially contacted position. Based on whether the input is associated with the primary axis or the secondary axis, information presented to the user about the set of content items is modified.

If the input is associated with the primary axis, the client device 110 modifies 225 the presented set of content items to include information associated with additional content items. For example, the client device 110 scrolls a list of content items to display information associated with content items not currently presented 210 in the list. Hence, the client device 110 presents information about additional content items when the input is associated with the primary axis. As an example, if the primary axis is vertical and the received input is vertically oriented, the client device 110 scrolls a list of content items to present information associated with additional content items, allowing the user to navigate through the list to view additional content items. In various embodiments, the additional content items that are presented by the modified list may be determined based on the direction of movement of the input along the primary axis. For example, if the input travels in a first direction along the primary axis one or more additional content items are presented by the modified list, while if the input travels in a second direction along the primary axis, alternative content items are presented by the modified list.

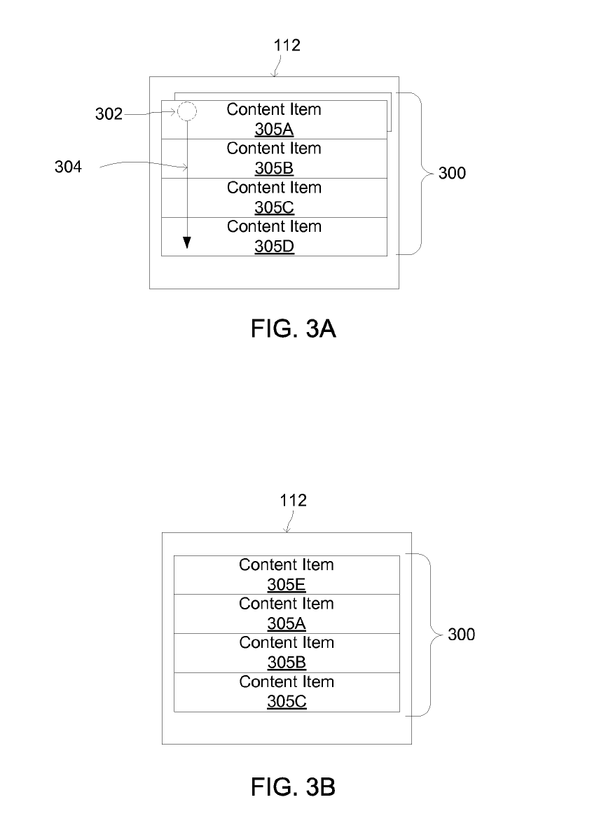

FIGS. 3A and 3B show an example of modifying 225 a presented list of content items when a received input is associated with the primary axis. FIG. 3A shows an example list 300 including content items 305A, 305B, 305C, 305D displayed on the display device 112. In FIG. 3A, an input 302 is received where the user interacts with the display device 112 along a path 304 associated with the primary axis. As shown in the example of FIG. 3A, the primary axis is a vertical axis, and the input 302 travels along a vertically-oriented path 304. In response to receiving the input 302, the content items in the list 300 are modified so one or more additional content items are presented in the list 300. For example, after receiving the input 302, the list 300 presents content items 305A, 305B, 305C, 305D, as shown in FIG. 3B.

However, if the received input is associated with the secondary axis, the client device 110 identifies 230 a content item associated with the received input. In one embodiment, the client device 110 identifies 230 a content item associated with a region of the display device 112 where the input is received 220. Additional information associated with the identified content item is retrieved 235 and the presented information associated with the identified content item is modified 240. In one embodiment, one or more dimensions of the regions of the display device 112 presenting the identified content item are increased and additional information associated with the identified content item is presented in the modified region of the display device 112. For example, the region of the display device 112 initially presenting the identified content item includes a subset of information associated with the content item, and a size of the region of the display device 112 is increased to provide additional information about the identified content item when a received input associated with the secondary axis is received.

The amount of additional information about the identified content item may be based in part on attributes of the received input. For example, the additional information associated with the content item presented is based on a distance traversed along the secondary axis by the input; the amount of additional information presented may be proportional to a distance the input traverses along the secondary axis. As a more specific example, as the received input traverses along the secondary axis, the region of the display device 112 presenting an identified content item increases and additional information associated with the identified content item is displayed; when the received input traverses a threshold distance along the secondary axis, additional information is retrieved from a network address associated with the identified content item and presented in the region of the display device 112 presenting the identified content item. In one embodiment, the user may interact with the information retrieved from the network address to access the network address associated with the identified content item. For example, if the identified content item is an advertisement, content from a web page associated with the advertisement is presented when the received input traverses the threshold distance along the secondary axis if the received input traverses at least a threshold distance along the secondary axis, and the user may navigate to the web page by accessing the presented content from the web page (e.g., contacting a region of the display device 112 in which a portion additional information from the network address is presented).

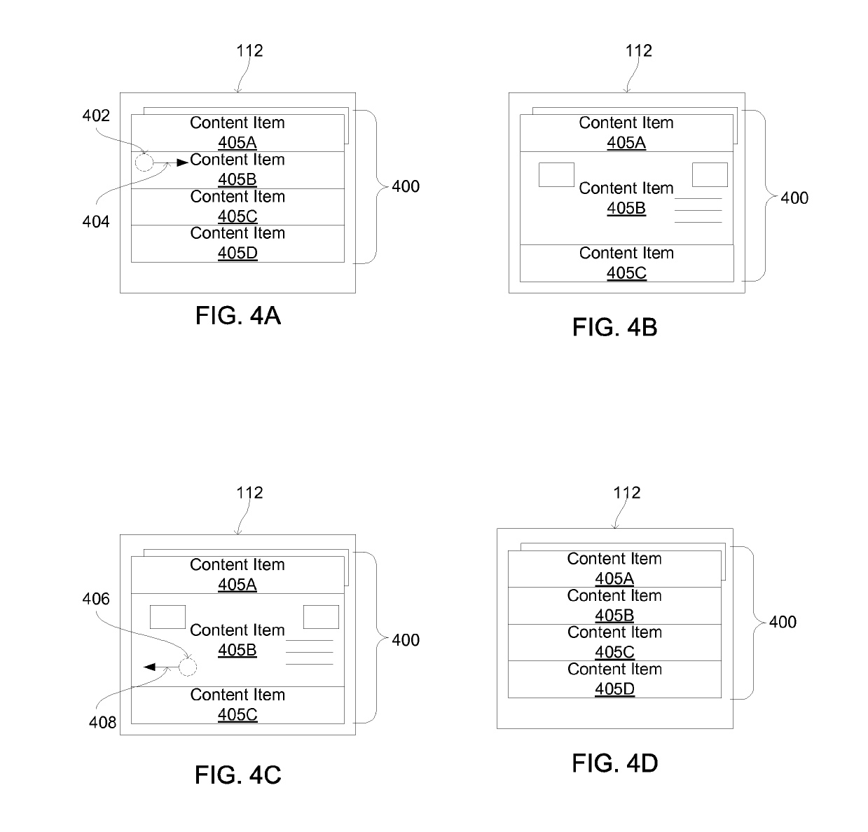

FIGS. 4A-4D show an example of modifying 225 presented information associated with an identified content item when a received input is associated with the secondary axis. FIG. 4A shows an example list 400 including content items 405A, 405B, 405C, 405D displayed on the display device 112. In FIG. 4A, an input 402 is received where the user interacts with the display device 112 by contacting the display device 112 and traversing a path 404 associated with the secondary axis while contacting the display device 112. As shown in the example of FIG. 4A, the secondary axis is a horizontal axis, with the path 404 in a horizontal direction. In response to determining the input 402 is associated with the secondary axis based on the path 404, a content item 405B associated with the input 402 is determined. For example, a content item presented within a threshold distance of the position of the display device 112 where the input was received is identified. As another example, a region of the display device 112

As shown in FIG. 4B, one or more dimensions of a region of the display device 112 in which the identified content item 405B is presented are increased. For example, the vertical dimension of the region of the display device 112 presenting the identified content item 405B is increased based on the received input 402. In some embodiments, a dimension of the region of the display device 112 presenting the identified content item 405B increases based at least in part on a rate at which the input 402 traverses the path 404 or based on a distance the path 404 of the input 402 traverses the secondary axis. For example, the vertical dimension of the region presenting the identified content item 405B increases at a rate proportional to the distance the path 404 of the input 402 traverses along the secondary axis, so the identified content item 405B is presented in a larger region of the display device 112 as the distance traversed by the path 404 of the input 402 along the secondary axis increases. In various embodiments, the regions of the display proximate to the region of the display in which the identified content item 405B is presented are resized, providing the user with an increased or a reduced amount of information associated with content items displayed in those regions. For example, a dimension of regions of the display device 112 presenting content items adjacent to the identified content item 405B (such as content items 405A, 405C in FIGS. 4A and 4B), along the primary axis is reduced, decreasing the amount of presented information associated with the content items adjacent to the identified content item 405B.

Additional input received while the region of the display device 112 presenting the identified content item is modified may further modify the presented content items. In FIG. 4C, an additional input 406 is received where the user interacts with the display device 112 along a path 406 associated with the secondary axis. For purposes of illustration, FIG. 4C shows the path 406 as being in an opposite direction than the path 404 associated with the input 402. As the input travels along the path 406 associated with the secondary axis, the region of the display area of the display device 112 presenting the identified content item 405B is reduced, decreasing the amount of information associated with the identified content item 405B that is presented to the user. This allows the user to increase or decrease the amount of information associated with the identified content item 405B by providing inputs traversing different directions along the secondary axis. For example, after traveling a threshold distance along the path 408, the list 400 includes information associated with content items 405A, 405B, 405B, 405D, as shown in FIG. 4D, allowing the user to view information associated with a larger number of content items 405A, 405B, 405C, 405D. For example, a dimension of a region presenting information associated with the identified content item 405B decreases proportionally to a distance along the secondary axis traversed by the path 408 associated with the additional input 406. As another example, after the path 408 associated with the additional input 406 traverses a threshold distance along the secondary axis, the region of the display device 112 presenting information associated with the identified content item 405B is modified to have default dimensions.

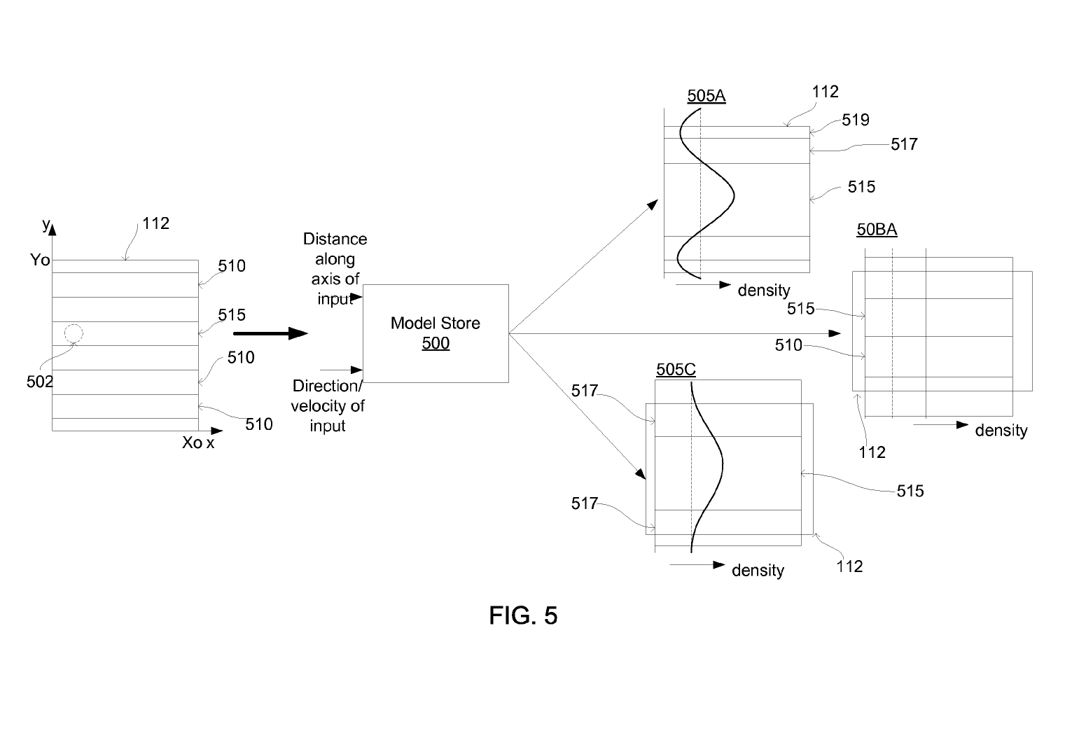

In various embodiments, presented content items may be modified in a variety of ways when an input associated with the secondary axis is received. One or more models describing modification of content items presented via the display device 112 may be included in the storage device 118 of the client device 110, with a model selected based on the received input. The selected model is applied to presentation of content items via the display device 112, which modifies dimensions of the regions of the display device 112 used for presenting content items using the display device 112. FIG. 5 shows an example of selection and application of a model for modifying presentation of content items by a display device 112.

In the example of FIG. 5, the display device 112 has a horizontal dimension Xₒ and a vertical dimension Yₒ, with various content items 510 displayed in the display device 112. When an input 502 interacting with a region of the display device 112 associated with a content item 515 is received, the client device 110 captures information describing the input 502. In one embodiment, the client device 110 determines a location along one or more axes of the display device 112 associated with the input 502. For example, the client device 110 determines a position along a horizontal axis and a position along a vertical axis associated with the input 502. The position of the input 502 along an axis identified by the client device 110 and may be used to retrieve a model from a model store 500 in the storage device 118. In the example of FIG. 5, the horizontal axis is a secondary axis, and the distance from the origin of the horizontal axis to the position of the display device 112 is used to identify a model from the model store 500. For example, various models in the model store 500 are associated with different distances from the origin of the secondary axis or with different ranges of distances from the origin of the secondary axis.

Alternatively, the client device 110 determines a direction and/or velocity associated with the received input 502. For example, a direction of movement is determined from portions of the display device 112 contacted during the input 502; a velocity associated with the input 502 may also be determined based on a time between the input contacting various portions of the display device 112. Models included in the model store 500 are associated with directions of motion and/or velocities, so a model corresponding to the direction and/or velocity of the input 502 is retrieved from the model store 500. Examples of determining a direction, velocity, or distance associated with an input are further described in International Application No. PCT/ZA2012/000059, filed Sep. 21, 2012, which is hereby incorporated by reference in its entirety.

Based on the model identified from the distance of the input 502 along an axis (e.g., the secondary axis) or identified from the direction and/or velocity associated with the received input, content items included in a list for presentation to the user are modified. For example, various models differently change the density of content items presented via the display device 112, allowing certain content items to occupy a greater area of the display device 112. For example, model 505A increases the area of the display device 112 used to display a content item 515 associated with the received input 502, while decreasing the areas of the display device 112 used to display content items 517, 519 adjacent to the content item 515 associated with the received input 502. Thus, model 505A allows a user to view more information associated with the content item 515 associated with the received input 502 while reducing the amount of presented information associated with the adjacent content items 517, 519.

As another example, model 505B increases the area of the display device 112 used to display each content item 510 by a uniform amount. Thus, applying model 505B to content items in a list causes each content item 510 to occupy a larger area of the display device 112, increasing the amount of information presented for the content item 515 associated with the input 502 as well as for other content items 510. However, because model 505B uniformly increases the display area allocated to each content item 510, fewer content items 510 are presented by the display device 112 at one time.

In another example, model 505C increases the area of the display device 112 used to display the content item 515 associated with the input 502 and increases the area of regions of the display device 112 used to display content items 517 adjacent to the content item 515 associated with the input 502 in the list of content items presented to the user. While model 505C increases the area of the display device 112 presenting the content item 515 associated with the input 502, model 505C also increases the area of the display device 112 presenting additional content items by a smaller amount, increasing the information associated with additional content items presented via the display device 112. While FIG. 5 shows models 505A, 505B, 505C, in other embodiments, any suitable model may be used to modify the areas of the display device 112 used to present various content items.

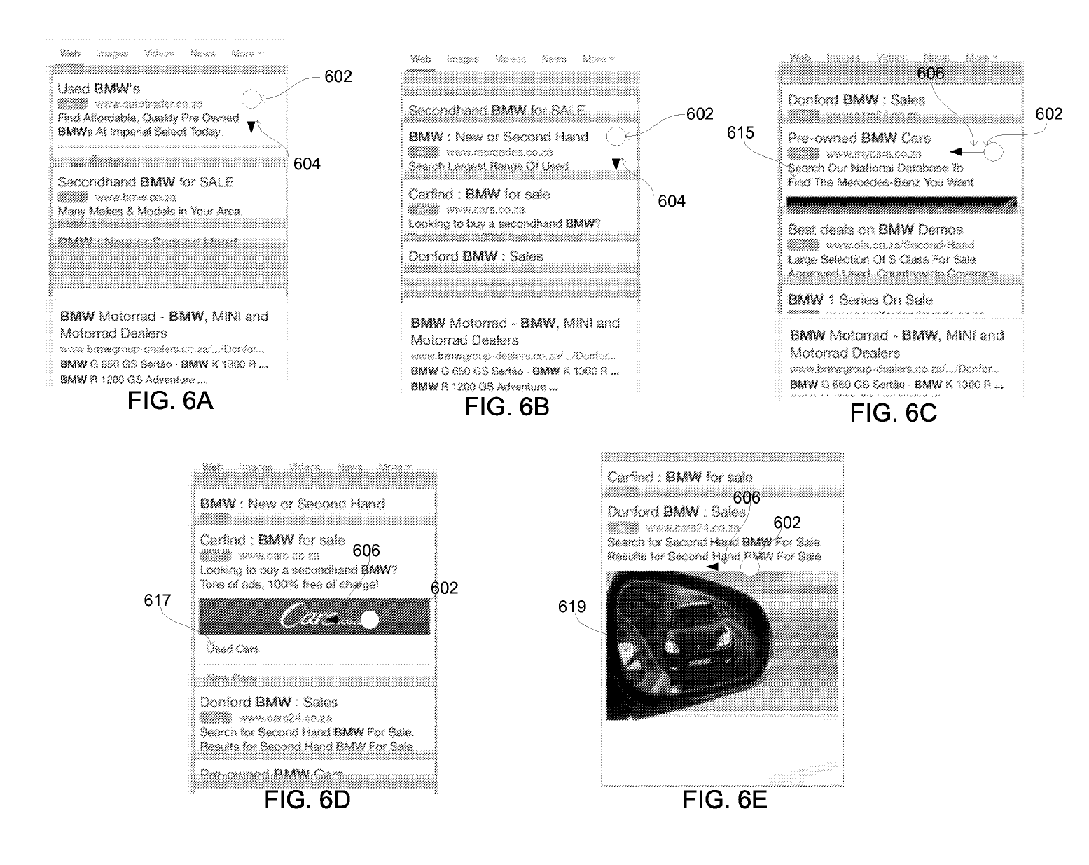

FIGS. 6A-6E show an example of modifying content items presented to a user based on an axis associated with a received input. In the example of FIGS. 6A-6E, a portion of a display device 118 includes content items that are modified based on an axis associated with the received input, while an additional portion of the display device 112 includes content items that are not modified based on the axis associated with the received input. In FIGS. 6A and 6B, a received input 602 traverses a path 604 associated with a primary axis, modifying the content items presented by the display device 118. For example, if the input traverses a vertical path, the client device 110 scrolls through various content items, presenting additional content items in the display device 112.

In FIG. 6C, the input 602 traverses a path 606 associated with the secondary axis, which is a horizontal axis in the example of FIGS. 6A-6E. Responsive to the input 602 having a direction associated with the secondary axis, an area of the display device 112 presenting a content item 615 associated with the input 602 is increased. This allows more information associated with the content item 615 to be presented. A model may be retrieved from a model store 500 as described above in conjunction with FIG. 5 to modify presentation of the content item 615 and additional content items. Hence, the direction of the input 602, the distance of the input 602 from an origin of the secondary axis, a velocity of the input 602, or any other suitable attribute of the input 602 may be used to modify presentation of the content item 615.

FIGS. 6D and 6E are examples where the distance of the input 602 from an origin of the secondary axis affect modification of presentation of a content item 617 associated with the input 602. In FIG. 6D, as the distance from the input 602 from an origin of the secondary axis increases, the area of the display device 112 used to present the content item 617 also increases, while the area of the display device 112 used to present additional content items decreases. For example, a different model is retrieved from the model store 505 as the distance from the input 602 to the origin of the secondary axis increases. In FIG. 6E, the distance from the input 602 to the origin of the secondary axis is a threshold distance, causing the client device 110 to retrieve and present information from a network address associated with a content item 619 associated with the input 602. For example, content from a web page associated with the content item 619 is presented in the display area presenting the content item 619. In one embodiment, accessing content retrieved from the web page causes the client device 110 to present the web page.

While FIGS. 6A-6E show an example where movement of an input 602 in orthogonal directions modifies presentation of content items, in other embodiments, content items may be modified based the input 602 moving in any suitable direction. For example, models including actions modifying content item presentation are stored in the storage device 118 and associated with one or more directions of motions. When an input is received via an input device 114, its direction of motion is determined as described in PCT Patent Application No. PCT/ZA2012/000059, filed Sep. 21, 2012, or PCT Application No. PCT/IB2014/001818, filed May 12, 2014, each of which is hereby incorporated by reference in its entirety. The determined direction of motion is compared to the stored information and an action associated with a similar direction (e.g., a direction within a threshold angle of the determined direction of motion) than the determined direction of motion is performed to modify presentation of the content item. Additional attributes of the input, such as its velocity, may also be used to identify an action performed to presented content items based on the received input. For example, different actions are associated with different velocities, and an action associated with a velocity within a threshold amount of the velocity of the input is selected and used to modify presentation of the content item; alternatively, an action associated with a velocity having a minimum difference from the velocity of the input is selected and used to modify presentation of the content item.

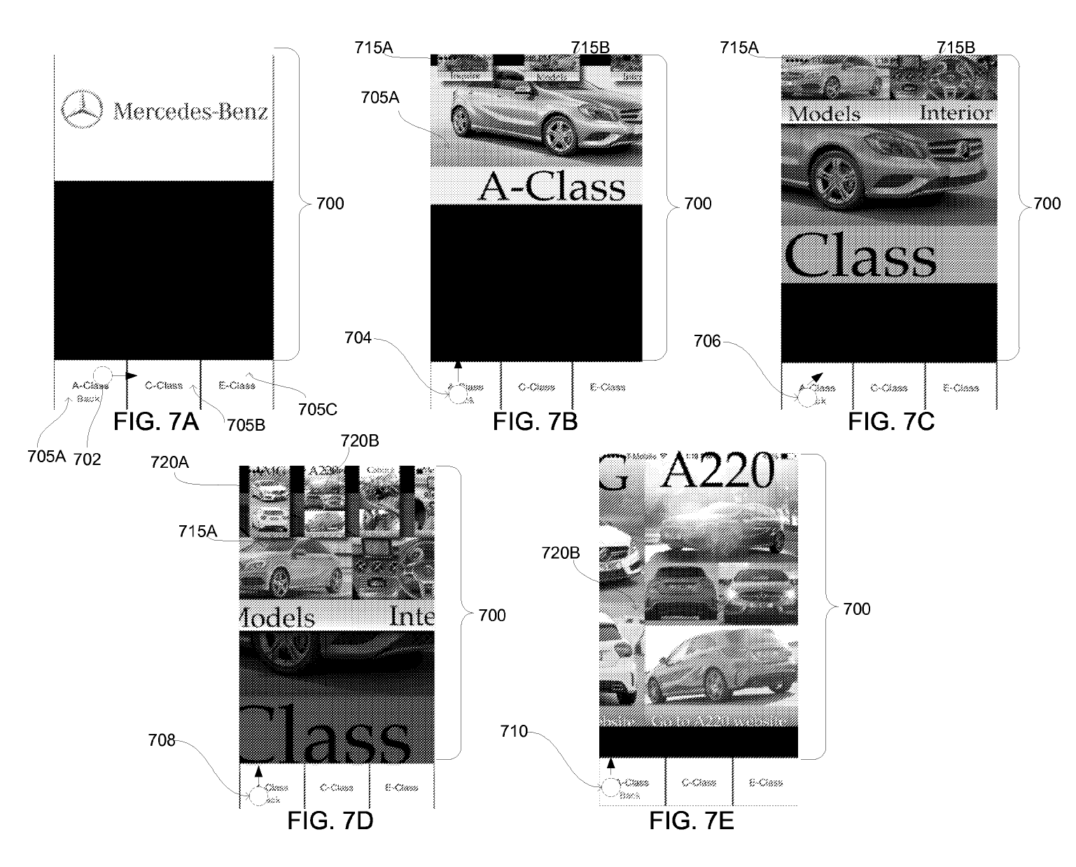

In addition to determining a model for modifying presentation of content items, determining a distance, a direction, and/or a velocity of a received input allows the client device 110 to navigate through a hierarchy of content items, an example of which is shown in FIGS. 7A-7E. In FIG. 7A, a received input 702 travels along a horizontal axis, allowing a user to select information associated with one of content items 705A, 705B, 705C for presentation in a display area 700 of a display device 112. As the input 702 traverses different regions, each displaying a content item 705A, 705B, 705C, along the a horizontal axis, information associated with a content item 705A, 705B, 705C displayed in a region of the display device 112 contacted by the input 702 is presented in the display area 700. In FIG. 7B, content associated with content item 705A is presented in the display area 700, and an input 704 having a different direction of motion than the input 702 is received. In one embodiment, the input 704 has a direction of motion that is orthogonal to the direction of motion of the input 702. For example, the input 704 has a vertical direction, while the input 702 has a horizontal direction. Based on the direction of the input 704, elements 715A, 715B associated with the content item 705A are displayed in the display area 700, allowing the user to view information about topics, categories, or other groups of information associated with the content item 705A based on a direction associated with the input 704. In one embodiment, the storage device 118 associates elements 715 associated with a content item 705 with one or more attributes of an input, so an element 715 presented in the display area 700 is determined based on a direction of motion of an input, a distance along an axis associated with an input, or other suitable information associated with an input.

As shown in FIG. 7C, an additional input 706 having a different direction of motion than the input 702 and the input 704 increases the portions of the display area 700 presenting elements 715A, 715B, simplifying user access to the elements 715A, 715B. Hence, the storage device 118 may include information associating different functionality with different directions of motion, different distances along an axis, different velocities, or other suitable attributes of an input. This allows a user to perform different functions as well as access different content items by modifying an attribute of an input (e.g., by changing a direction of motion of an input, by changing a velocity with which an input traverses a direction of motion). Another input 708 having a different direction of motion, or other differing attribute, from the additional input 706, causes one or more components 720A, 720B associated with a selected element 715A to be presented in the display area 700. Similarly, an input 710 displays content associated with a selected component 720B based on an attribute of the input 710, such as a direction of motion of the input 710.

For purposes of illustration, FIGS. 7A-7E depict inputs received in a specific portion of the display device 112 (e.g., a portion of the display device 112 within a threshold distance of a lower boundary of the display device 112). However, in other embodiments, inputs causing the above-described functionality, or similar functionality, may be received by interacting with any suitable portion of the display device 112. Additionally, in some embodiments, a position within the display device 112 where an input is received affects an action associated with a received input, and as the input contacts different regions of the display device 112, one or more actions associated with the input are modified. For example, if input 702, which has a horizontal direction of motion, is received in a portion of the display area 700, rather than select information associated with one of content items 705A, 705B, 705C for presentation in a display area 700, the input 702 pans the content presented in the display area 700 to present different portions of the content to the user. Thus, the direction of movement associated with an input, as well as the input's position relative to one or more boundaries associated with regions of the display device 112, may be used to determine actions provided by the input.

Thus, one or more attributes of a received input may be used to modify the content items presented to a user, allowing a user to access a larger number of content items using display devices 112 with smaller sizes or to more easily navigate through hierarchical data. For example, associating direction of motion with different content items organized in a hierarchy allows the user to access different content items by modifying the directionality of an input. This may allow a user to more easily access different entries in a contact listing, in search results, in a media library, or other suitable organization of data. Similarly, modifying display of content items based on directionality of an input or distance of an input from a reference axis increases the amount of content capable of being presented to the user in a limited display area. For example, a greater number of potential advertisements may be presented to a user by initially displaying a limited amount of information about the advertisements and increasing the display area presenting various advertisements based on a model determined from an attribute of a received input.

### Summary

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
storing a plurality of models in a client device, each model including one or more actions for modifying one or more regions of a display device presenting content;
displaying a plurality of content items in regions of the display device of the client device;
receiving an input from a user via an input device of the client device, the input associated with a region of the display device displaying a content item;
determining one or more attributes of the input;
selecting a model from the plurality of models based on the determined one or more attributes of the input; and
modifying one or more dimensions of the region of the display device associated with the input based on one or more actions included in the selected model; and
displaying the content item based on the modified one or more dimensions of the region of the display device associated with the input.

2. The method of claim 1 wherein modifying one or more dimensions of the region of the display device associated with the input based on one or more actions included in the selected model comprises:
increasing an area of the region of the display device associated with the input.

3. The method of claim 1, wherein modifying one or more dimensions of the region of the display device associated with the input based on one or more actions included in the selected model comprises:
modifying one or more dimensions of one or more additional regions of the display device based on one or more actions included in the selected model.

4. The method of claim 3, wherein modifying one or more dimensions of the region of the display device associated with the input based on one or more actions included in the selected model comprises:
increasing an area of the region of the display device associated with the input; and
decreasing areas of one or more regions of the display device adjacent to the region of the display device associated with the input.

5. The method of claim 3, wherein modifying one or more dimensions of the region of the display device associated with the input based on one or more actions included in the selected model comprises:
increasing an area of the region of the display device associated with the input; and
increasing areas of one or more regions of the display device adjacent to the region of the display device associated with the input.

6. The method of claim 1, wherein determining one or more attributes of the input comprises:
determining whether a direction of motion of the input is associated with a secondary axis of the display device.

7. The method of claim 6, wherein selecting the model from the plurality of models based on the determined one or more attributes of the input is based at least in part on whether the direction of motion of the input is associated with the secondary axis of the display device.

8. The method of claim 1, wherein an attribute of the input comprises a position of the input along an axis of the display device.

9. The method of claim 1, wherein an attribute of the input comprises a direction of motion of the input.

10. The method of claim 1, wherein an attribute of the input comprises a velocity of the input.

11. A method comprising:
storing a plurality of models in a client device, each model including one or more actions for modifying one or more regions of a display device presenting content;
displaying a plurality of content items in regions of the display device of the client device;
receiving an input from a user via an input device of the client device, the input associated with a region of the display device displaying a content item;
determining one or more attributes of the input;
determining whether a direction of motion of the input is associated with a primary axis of the display device or a secondary axis of the display device;
responsive to determining the direction of motion of the input is associated with the second axis of the display device, selecting a model from the plurality of models based on the determined one or more attributes of the input; and
modifying one or more dimensions of the region of the display device associated with the input based on one or more actions included in the selected model; and
displaying the content item based on the modified one or more dimensions of the region of the display device associated with the input.

12. The method of claim 11, wherein determining whether the direction of motion of the input is associated with a primary axis of the display device or a secondary axis of the display device comprises:
determining whether the direction of motion of the input is less than a threshold angle from the secondary axis;
determining the direction of motion of the input is associated with the secondary axis if the direction of motion of the input is less than the threshold angle from the secondary axis.

13. The method of claim 11, wherein the primary axis is orthogonal to the secondary axis.

14. The method of claim 11 wherein modifying one or more dimensions of the region of the display device associated with the input based on one or more actions included in the selected model comprises:
increasing an area of the region of the display device associated with the input.

15. The method of claim 11, wherein modifying one or more dimensions of the region of the display device associated with the input based on one or more actions included in the selected model comprises:
modifying one or more dimensions of one or more additional regions of the display device based on one or more actions included in the selected model.

16. The method of claim 15, wherein modifying one or more dimensions of the region of the display device associated with the input based on one or more actions included in the selected model comprises:
increasing an area of the region of the display device associated with the input; and
decreasing areas of one or more regions of the display device adjacent to the region of the display device associated with the input.

17. The method of claim 15, wherein modifying one or more dimensions of the region of the display device associated with the input based on one or more actions included in the selected model comprises:
increasing an area of the region of the display device associated with the input; and
increasing areas of one or more regions of the display device adjacent to the region of the display device associated with the input.

18. The method of claim 11, wherein an attribute of the input comprises a position of the input along an axis of the display device.

19. The method of claim 11, wherein an attribute of the input comprises a direction of motion of the input.

20. The method of claim 11, wherein an attribute of the input comprises a velocity of the input.
